(19) United States
(12) Patent Application Publication
(10) Pub. No.: US 2010/0121998 A1
(43) Pub. Date: May 13, 2010

(54) COMPUTER OPERATING DEVICE

(75) Inventor: Beaufort Galland, Victoria (AU)

Correspondence Address: HOVEY WILLIAMS LLP, 10801 Mastin Blvd., Suite 1000, Overland Park, KS, 66210, US

(73) Assignee: CBB INTERNATIONAL PTY LTD, Victoria (AU)

(21) Appl. No.: 12/597,415

(22) PCT Filed: Apr. 23, 2008
(86) PCT No.: PCT/AU08/00559

§ 371 Date: Oct. 23, 2009

(30) Foreign Application Priority Data
Apr. 24, 2007 (AU) 2007902170

(51) Int. Cl. G06F 13/38

(52) U.S. Cl. 710/74; 713/1; 711/103

(57) ABSTRACT

An operating device (10) for operating a computer, the operating device (10) including a data storage device (12). A detection device is stored on the data storage device (12) for detecting the type of computer hardware provided in the computer. An override system is stored on the data storage device (12) for at least partially overriding a computer operating system. A replacement operating system is stored on the data storage device (12) for operating the computer at least partially in place of the computer operating system. The operating device includes a device data transmission port (20) for transferal from the data storage device (12) of override system instructions from the override system, and replacement operating system instructions from the replacement operating system through a computer access port and to the computer.

The present invention relates generally to computers. More specifically, the present invention relates to an alternative way of operating a computer and will herein be generally described in that context. However, it is to be appreciated that the invention may be adapted for use in other applications.

The advent of laptop computers has dramatically improved computer portability. When compared to desk-top computers, it is a far easier proposition to pack up and travel with a laptop computer than it is a desk-top computer.

Nevertheless, it is often inconvenient to travel with a laptop. Laptops generally occupy valuable luggage space, which can be used for carrying other travel items. Laptops also generally weigh several kilograms, which can undesirably add significantly to the weight of a traveler's luggage.

Laptops are valuable items and, as such, are often sought after items by thieves. In the context of commercial passenger aircraft travel, where possible, persons traveling with laptops generally carry their laptops in hand luggage rather than be separated from and potentially suffer the theft of their laptop from their check-in luggage.

Theft of laptops from hotels, motels and other accommodation types is also relatively common, which can present problems to individuals traveling with laptops, who must ensure their laptops are securely stored when not being used.

One option available to individuals not able or willing to take their computer with them when traveling is to use another computer available to them at their destination. This solution overcomes the above mentioned problems associated in traveling with their computer. Undesirably, however, the computer(s) available at the traveler's destination may not be configured to suit the traveler's specific requirements in terms of operating system and software.

It would therefore be desirable to enable an individual access to their computer when traveling without the need to actually travel with their computer.

The above discussion is provided in the context of a user's computer requirements while traveling. The term ‘traveling’ is to be understood broadly to refer to the fact that the user is unable to access their computer or is otherwise separated from their personal computer, whether or not the user is actually traveling. For example, similar problems may exist for an individual wishing to access their work or office computer from home.

According to one broad aspect of the present invention, there is provided an operating device for operating a computer. The operating device includes a data storage device. A detection device is stored on the data storage device. The detection device is provided for detecting the type of computer hardware provided in the computer. An override system is stored on the data storage device. The override system is provided for at least partially overriding a computer operating system. A replacement operating system is also stored on the data storage device. The replacement operating system is provided for operating the computer at least partially in place of the computer operating system. The operating device includes a device data transmission port for transferal from the data storage device of override system instructions from the override system and replacement operating system instructions from the replacement operating system through a computer access port and to the computer.

The override system is provided for at least partially overriding, but more preferably completely overriding or bypassing and/or deactivating the operating system of the host computer the user wishes to use, once the detection device has established the type of hardware on the computer.

In a preferred form, the operating device is externally powered.

The device may include a flash memory storage device. In such an arrangement, the override system and the replacement operating system may be at least partially stored on the flash memory storage device.

The data storage device may also be used to store desktop applications, as well as other software, files and information.

The flash memory storage device may include one or more flash memory drives. The flash memory storage device may include one or more memory cards.

In a preferred form, a strip raid format is used in order to increase the access speed to data across each of the memory cards. Such an arrangement makes the present invention feasible because it improves the operating efficiency of the device thereby enabling it to operate at a sufficiently high speed.

The operating device may include an enhancer for enhancing the operating speed of the computer when running the computer's regular operating system and/or replacement operating system. In this respect, the enhancer may include flash memory RAM for enhancing the operating speed of the computer operating system and/or replacement operating system.

The operating device may include security features to minimize the potential for unauthorized use of the device. The security features may include at least one of a voice recognition device, a fingerprint recognition device, a pulse monitor, a password recognition device and an internet authentication device.

Security features of the above sort may include one or more of voice recognition software, fingerprint recognition software, pulse monitoring software, password recognition software and internet authentication software stored on the data storage device.

It will be convenient to hereinafter describe a preferred embodiment of the invention with reference to the accompanying drawings. The particularity of the drawings is to be understood as not limiting the preceding broad description of the invention.

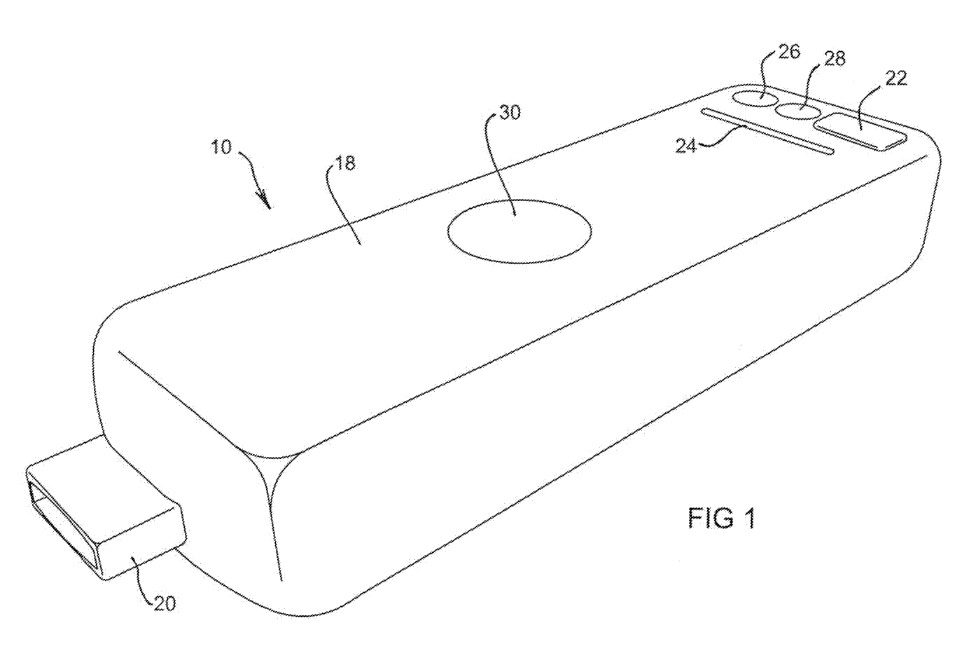

FIG. 1 is a perspective view of an operating device according to one embodiment of the present invention.

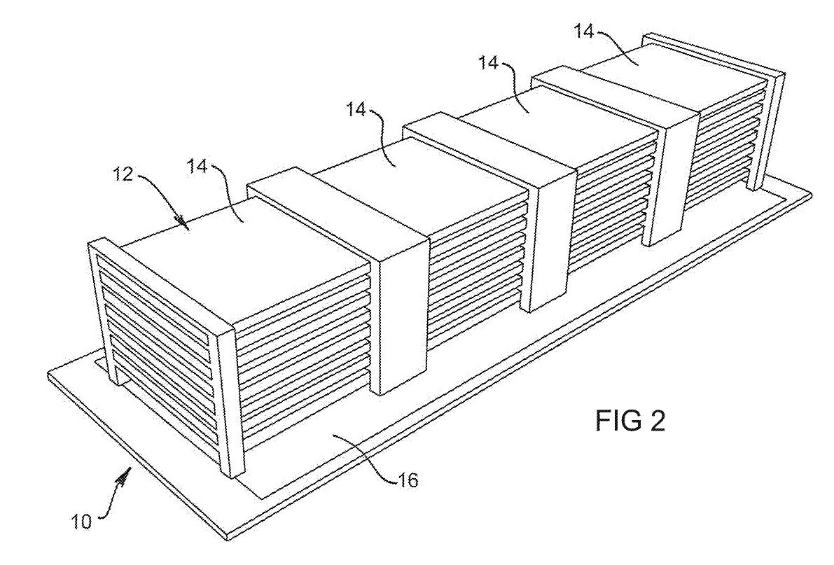

FIG. 2 is a perspective view of the operating device of FIG. 1 with the outer casing removed.

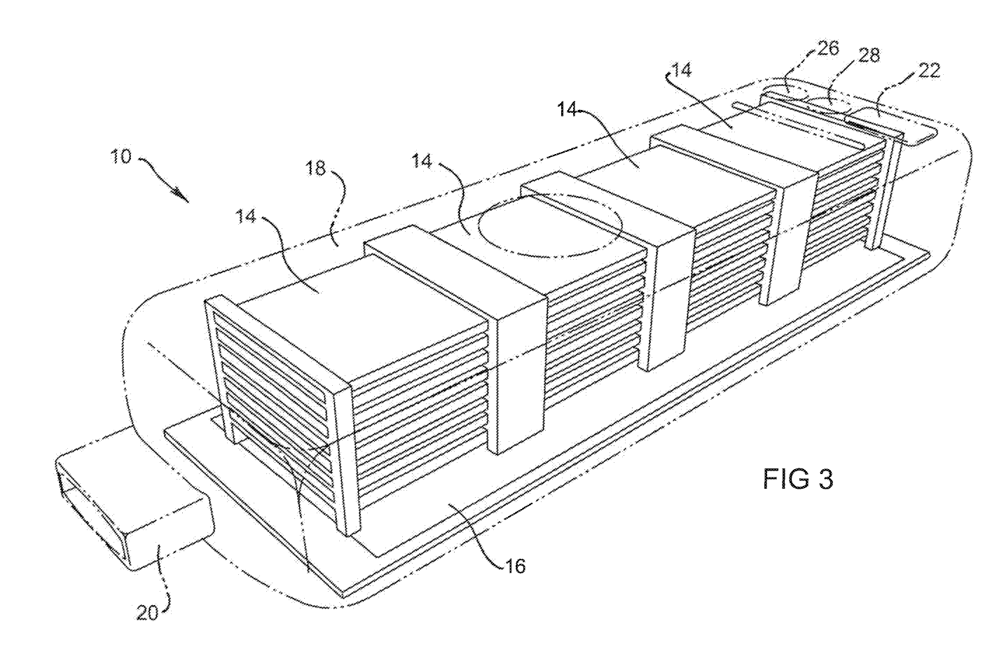

FIG. 3 is a perspective view of the operating device of FIG. 1 with the outer casing provided in a partially transparent form.

Referring to the drawings, there is illustrated an operating device 10 for operating a computer (not illustrated).

The device 10 has been specifically designed for a user to operate a host computer as if it were their own computer. In this respect, the user simply connects the device 10 to a computer the user wishes to use, whereupon the user's preferred operating system and/or other software stored in the device 10 at least partially replaces that provided on the host computer.

In the illustrated arrangement, the data storage device 12 is a flash memory storage device. The operating device 10 includes a data storage device 12 in the form of thirty-two 2 GB memory cards 14 (only some of which have been numbered in the drawings) connected to a printed circuit board 16. It is to be appreciated that any suitable number and type/size of memory cards and circuit board(s) may be used. Memory cards are used in the illustrated embodiment because of their robustness, although any other suitable memory storage device may be used.

The memory cards 14 and printed circuit board 16 are conveniently and robustly housed in a metal or rigid plastic housing 18.

A detection device is stored on the data storage device 12. The detection device is provided for initially detecting the type of computer hardware provided in the computer.

The device 10 includes an override system, which is stored on the data storage device 12. The override system is provided in the form of software loaded on the memory cards 14. The override system is provided for at least partially overriding, but more preferably completely overriding or bypassing and/or deactivating the operating system of the host computer the user wishes to use, once the detection device has established the type of hardware on the computer.

A replacement operating system is also stored on the memory cards 14. The replacement operating system is provided for operating the host computer with the user's preferred operating system and/or other software at least partially in place of the operating system and/or other software which has been at least partially overridden or deactivated by the override system. More than one replacement operating system may in fact be stored on the memory cards 14, to enable the user to use the device with, for example, either an IBM-compatible computer or Mac computer.

A strip raid format is used in order to increase the access speed to data across each of the memory cards 14. Such an arrangement makes the present invention feasible because it improves the operating efficiency of the device 10 thereby enabling it to operate at a sufficiently high speed.

The data storage device may be used to store desktop applications, as well as other software, files and information that may be required by the user.

The operating device 10 includes a device data transmission port in the form of a USB connector (or plug) 20. The connector 20 is provided for transferal from the device 10 of override system instructions from the override system, and replacement operating system instructions from the replacement operating system through a mating USB plug receiver provided on the host computer. The device 10 includes a USB connector because of its particular robustness. However, any other suitable connector type may be adopted if desired.

Being an externally powered flash memory storage device, the user can conveniently carry and store the device 10 with the override system and replacement operating system permanently stored on the memory cards 14 for use with a host computer. When connected to a host computer, the device 10 will operate the host computer with the user's own operating system rather than the operating system of the host computer. In this way, the host computer adopts the look and operating characteristics of the user's own computer. As stated, the data storage device may also be used to store desktop applications, as well as other software, files and information that may be required by the user.

The device 10 is a flash memory device and, as such, derives its operating power from the host computer only upon being plugged into the host computer.

The operating device 10 includes an enhancer, in the form of flash memory RAM, for enhancing the operating speed of the host computer. The enhancer may be used in conjunction with one or more of the override system, replacement operating system and other software stored on the device 10 to enhance the speed of those systems/software on the host computer. Alternatively, the enhancer may be used to boost the operating speed of the regular operating system and/or other software of the host computer.

The operating device 10 may include security features to minimize the potential for unauthorized use of the device 10 if, for example, the device 10 was lost or stolen. This feature may be of great benefit, considering the type of data that could conceivably be stored on the device 10, including desktop applications, as well as other software, files and information (including personnel information) that may be required by the user.

The security features may include at least one of:
a voice recognition device for first recognizing the voice of an authorized user;
a fingerprint recognition device for recognizing the finger print(s) of an authorized user;
a pulse monitor (which may be used in conjunction with a fingerprint recognition device) for detecting whether a finger or other body part has a pulse;
a password recognition device for enabling an authorized user to input a user password; and
an internet authentication device.

These devices may adopt any suitable form. Any one or more of these security features may be included to ascertain that the person attempting to use the device 10 is an authorized user prior to use of the device with a new host computer or, for example, following a period of non-use of the device 10 with a given host computer.

Security features of the above sort may include one or more of voice recognition software, fingerprint recognition software, pulse monitoring software, password recognition software and internet authentication software stored on the data storage device.

In this respect, the device 10 includes a microphone 22 on the housing 18 for use with the voice recognition software provided on the device 10 to confirm that a person wishing to use the device is an authorized user.

The device 10 also includes a fingerprint reader 24, and a pair of pulse readers 26, 28 provided on the housing 18. These readers are linked to fingerprint recognition software and pulse detection software loaded on the device 10 to confirm that a person wishing to use the device 10 is an authorized user. In use, it is envisaged that a person would, in a single movement, slide a finger over the fingerprint reader 24 and then onto the pulse readers 26,28, whereupon the finger would remain until a pulse reading was obtained.

The device 10 also includes an indicator 30 provided on the housing 18 for confirming that the device 10 is correctly connected to a host computer. The device 10 is of a small size, similar to the size of commercially available flash drives, Hence, the device 10 is portable and easily carried.

The device 10 can be conveniently carried by an individual and used to operate a host computer substantially as if it was their own computer, by temporarily overriding the host computer's operating system and/or other software with a replacement operating system and/or other software preferred or required by the user.

The computer user can then use the host computer substantially as if it was their computer containing their preferred operating system, other software, files and other information. Once the user has finished using the host computer, the device is disconnected from the computer and the host computer returns to operating by way of its normal operating system and other software.

Software for disconnecting the device 10 from the host computer may be required.

Finally, it is to be understood that various alterations, modifications and/or additions may be introduced into the construction and arrangement of the parts previously described without departing from the spirit or ambit of this invention.

1. An operating device for operating a host computer, the operating device comprising:
a portable data storage device which is connectable to a host computer and which uses a strip raid format to access data stored thereon;
a detection device stored on the data storage device for detecting the type of computer hardware provided in the host computer;
an override system stored on the data storage device for at least partially overriding a computer operating system of the host computer;
a replacement operating system stored on the data storage device for operating the host computer at least partially in place of the computer operating system of the host computer;
the operating device comprising a device data transmission port for transferral from the data storage device of:
override system instructions from the override system, and
replacement operating system instructions from the replacement operating system through a computer access port and to the host computer.

2. An operating device according to claim 1, wherein the device is externally powered.

3. An operating device according to claim 1, wherein the data storage device comprises a flash memory storage device.

4. An operating device according to claim 3, wherein the flash memory storage device comprises at least one flash memory drive.

5. An operating device according to claim 3 wherein the flash memory storage device comprises at least one memory card.

6. An operating device according to claim 1, wherein the operating device comprises an enhancer for enhancing the operating speed of at least one of the computer operating system, replacement operating system and other software.

7. An operating device according to claim 6, wherein the enhancer comprises memory RAM.

8. An operating device according to claim 1, comprising security features.

9. An operating device according to claim 8 wherein the security features comprise at least of a voice recognition device, fingerprint recognition device, at pulse monitor, a password recognition device and an internet authentication device.

10. An operating device according to claim 9 comprising at least one of voice recognition software, fingerprint recognition software, pulse monitoring software, password recognition software and internet authentication software.

11. (canceled)
